(19) United States
(12) Patent Application Publication
(10) Pub. No.: US 2007/0034834 A1
(43) Pub. Date: Feb. 15, 2007

(54) Compound, phosphor composition and light-emitting device containing the same

(76) Inventors: Yu-Huan Liu, Tao-Yuan Hsien (TW); Ru-Shi Liu, Hsin-Chu Hsien (TW); Yi-Shan Lin, Nan-Tou Hsien (TW); Chuen-Ming Gee, Tao-Yuan Hsien (TW); Ching-Jang Lin, Tao-Yuan Hsien (TW); Biing-Jyh Weng, Taipei Hsien (TW); Tzong-Liang Tsai, Hsin-Chu City (TW); Tzer-Perng Chen, Hsinchu (TW)

Correspondence Address: NORTH AMERICA INTELLECTUAL PROPERTY CORPORATION, P.O. BOX 506, MERRIFIELD, VA, 22116, US

(21) Appl. No.: 11/164,018

(22) Filed: Nov. 7, 2005

(30) Foreign Application Priority Data
Aug. 12, 2005 (TW) 094127527

(51) Int. Cl. H01J 63/04; H01J 1/62

(52) U.S. Cl. 252/301.4 F; 313/486; 313/485; 257/98

(57) ABSTRACT

A compound represented by the following formula:
SrₓM_{y}Al_{z}Si_{12-z}N_{16-z}O_{2+z} wherein, M is selected from the group consisting of rare earth elements and yttrium, x>0, y>0, x+y=2, and 0≦z≦5. The compound may be used as a phosphor. It emits a visible light upon being excited by a blue light and/or an ultra-violet light. When M is Eu, the compound emits a yellow-green light upon being excited by a blue light and/or an ultra-violet light.

### BACKGROUND OF THE INVENTION

1. Field of the Invention

The present invention relates to a compound, and particularly to a compound functioning as a phosphor emitting a visible light upon being excited by a blue light and/or an ultra-violet light.

2. Description of the Prior Art

A white light is a mixed light of multi-colors and sensed by a human eye as a white light. The white light comprises at least two wavelengths of lights. When a human eye perceives red, blue, and green lights at the same time, or perceives blue and yellow lights at the same time, it senses a white light. A white light-emitting diode (LED) is thus made in accordance with such principle.

Conventional methods for making white light-emitting diodes have four types as follows. The first method type is to use three LEDs with InGaAlP, GaN, and InGaN light-emitting material, with the controls of different electric currents passing the LEDs, to emit red, green, and blue lights respectively. Since the three diode chips are placed in one lamp, a lens of the lamp may mix the emitted lights to produce a white light. The second method type is to use two LEDs with GaN and GaP light-emitting material, with the controls of electric currents passing the LEDs, to emit and mix blue and yellow green light for producing a white light. Such two types of white light-emitting diode devices may have a luminous efficiency up to 20 lm/W. One disadvantage of the two types of devices is that a normal white light cannot be obtained when one of the different LEDs used together is failed. In addition, because the forward biases for the different LEDs are different, multiple sets of control circuit are needed, and thus, the cost is relatively high.

The third method type is to use an InGaN blue LED and yellow YAG (yttrium aluminum garnet) phosphor to produce a white light, as proposed by Nichia Chemical of Japan in 1996. The device luminous efficiency may reach 15 to 30 lumens per watt (Im/w) and only one LED chip is needed. Accordingly, the manufacturing cost is much lower. As the skills for making the phosphor are well developed, many related articles are commercialized. However, in the second and the third types of methods, the principle of complimentary hues is utilized to produce a white light. The continuity for the wavelength distribution in the spectrum is not as real as the sun light, and thus in the resulting mixed color lights, a non-uniform color will exist in the range of visible light (400 nm to 700 nm). This causes a relatively low color saturation. Although human eyes neglect such difference and only perceive a white light, but under the detection by optical detecting devices (such as a video camera or a camera) with high precision, the color rendition is substantially low. That is, the colors, after recovered, will exhibit an error. Therefore, the white light sources produced by such two types of methods are only suitably used as simple illuminants.

The fourth method type to produce a white light, as developed by Sumitomo Electric Industries, Ltd, in 1999, January, forms a CdZnSe film on a ZnSe single crystalline substrate, and then the film emits blue light after electric power is supplied, and at the same time, the substrate receives part of the blue light and emits yellow light. The blue and the yellow light compliment each other to form a white light. In such method, a single LED chip is used with an operation voltage of only 2.7V, lower than 3.5 V required by GaN LED. A white light can be obtained without need of phosphor material. However, the luminous efficiency is only 8 lm/W. Therefore, a further improvement is required for such technique to be used in practice.

In the future, it will be possible to use a known ultra-light-emitting diode for exciting conventional phosphors to produce a white light as an illumination device (i.e. replacing fluorescent lamps or electric bulbs). In the conventional white light source emitting three wavelengths of lights, more than three phosphors are generally used for enhancing the color rendering index. When multi phosphors are employed and desired to emit the fluorescent lights, one of the prerequisites is that the exciting light used can be absorbed by all of these phosphors, and the absorbance coefficients of the phosphors for the exciting light can not be too different. The quantum efficiencies of light-to-energy transformation are preferably as approximate as possible. Thereby, the amounts of phosphors for three primary colors can be suitably regulated to obtain a white light. However, the exciting energy for the blue LED and the exciting energy for the YAG phosphor are not exactly same. Accordingly, when a light with a wavelength less than 400 nm is used as an exciting light, the light intensity of emission is reduced, and, in addition, the white LED made by such method emits a non-uniform color light having a poor color rendition.

Therefore, a novel phosphor is still needed for use in light-emitting devices, such as light-emitting diodes.

### SUMMARY OF THE INVENTION

The object of the present invention is to provide a compound which is an oxygen-nitrogen compound phosphor material that can be excited by a blue light and/or an ultra-violet light and emit visible light, and is applicable in light-emitting devices.

Another object of the present invention is to provide a phosphor composition containing the compound according to the present invention. The phosphor composition can be excited by a blue light to emit a light which is mixed together with the blue light to become a white mixed-light. The manufacturing of the phosphor composition is simple, and the resulting white light has a high color rendition.

Still another object of the present invention is to provide a light-emitting device including the compound according to the present invention.

Yet still another object of the present invention is to provide a white light-emitting device including the phosphor composition according to the present invention.

The compound according to the present invention may be represented by the following formula:
SrₓM_{y}Al_{z}Si_{12-z}N_{16-z}O_{2+z}

wherein, M is selected from the group consisting of rare earth elements and yttrium, x>0, y>0, x+y=2, and 0≦z≦5.

The phosphor composition according to the present invention comprises a compound represented by the following formula and a phosphor:
SrₓEu_{y}Al_{z}Si_{12-z}N_{16-z}O_{2+z}

wherein, x>0, y>0, x+y=2, and 0≦z≦5. The phosphor emits a red light upon being excited by a blue light and/or an ultra-violet light. Each component is present in an amount such that the phosphor composition emits a light upon being excited by the blue light and/or the ultra-violet light to mix with the blue light to produce a white light.

The light-emitting device according to the present invention comprises an exciting light source and the compound according to the present invention.

The white light-emitting device according to the present invention comprises an exciting light source emitting a blue light and/or an ultra-violet light and a phosphor composition positioned in a light path of the exciting light source for receiving the blue light and/or the ultra-violet light. The phosphor composition contains the compound of the present invention.

The compound of the present invention is an oxygen-nitrogen compound and may be used as a phosphor material. When it is excited by a blue light and/or an ultra-violet light (e.g. having a wavelength of 380 nm to 480 nm), it emits a visible light. Especially, the compound may emit yellow-green light for use in the industry. When the compound is utilized in a light-emitting device in a proper amount mixed with a second phosphor emitting a red light upon receiving a blue light and/or an ultra-violet light, with a proper light intensity ratio, a white light of high color temperature and a high color rendition can be produced. Therefore, the compound and the phosphor composition may be suitably applied in the light-emitting device, especially the light-emitting diode devices.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows an excitation spectrum of the phosphor SrEuAl₂Si₁₀N₁₄O₄ in one embodiment of the compound according to the present invention;

FIG. 2 shows an emission spectrum of the phosphor SrEuAl₂Si₁₀N₁₄O₄ in one embodiment of the compound according to the present invention;

FIG. 3 shows CIE chromaticity coordinates indicating a position of point A obtained from the transformation of the emission spectrum shown in FIG. 2 using a computer simulation;

FIG. 4 shows an emission spectrum of the phosphor SrEuAl₂Si₁₀N₁₄O₄ in one embodiment of the compound according to the present invention;

FIG. 5 shows CIE chromaticity coordinates indicating a simulated position of point E obtained from the transformation of the emission spectrum shown in FIG. 4 using a computer simulation, and the triangle indicates the theoretical position for a white light.

### DETAILED DESCRIPTION

The compound according to the present invention has a chemical formula (I) as follows:
SrₓM_{y}Al_{z}Si_{12-z}N_{16-z}O_{2+z} (I)

In which, M is one selected from the group consisting of rare earth elements and yttrium. x>0. y>0. x+y=2. 0≦z≦5. Among the rare earth elements, Ce, Pr, Eu, Tb, Yb, and Er, for example, are preferred.

The compound of chemical formula (I) can be excited by a blue light and/or an ultra-violet light, such as a light with a wavelength of 380 nm to 480 nm, and emit a visible light. Therefore, the compound is a phosphor material and can be utilized in a light-emitting device.

When M in the formula (I) is Eu, a compound having a formula (II) as follows is obtained:
SrₓEu_{y}Al_{z}Si_{12-z}N_{16-z}O_{2+z} (II)

in which, x>0, y>0, x+y=2, and 0≦z≦5.

The compound of the formula (II) can be excited by a blue light and/or an ultra-violet light, such as a light with a wavelength of 380 nm to 480 nm to emit a yellow-green light, and can be utilized in a light-emitting material and a light-emitting device. For example, the compound may be mixed with a red light-emitting phosphor in a proper ratio to form a phosphor composition. The red light-emitting phosphor is a phosphor which can be excited by a blue light and/or an ultra-violet light and then emit a red light. The phosphor composition, upon being excited by a blue light and/or an ultra-violet light, with a suitable intensity of blue light together, can produce a white mixed-light. The red light phosphor may be, for example, but not limited to CaS:Eu; SrS:Eu; Y₂O₂S:Eu; Y₂O₃:Eu; Y₂O₃:Eu, Bi; or Ca-α-SiAlON:Pr. The mixing ratio for the compound of formula (II) and the red light-emitting phosphor and the intensity ratio for the emitted light intensity and the blue light intensity depend on the types used. Those skilled in the art should be able to easily determine the proper amounts for the components used.

The compound and the phosphor composition according to the present invention may be used alone or employed in light-emitting devices, such as illumination devices, decorating lights, advertising panels, or backlight units for display devices.

In case the compound of the present invention is employed in the light-emitting device, the light-emitting device includes an exciting light source and the compound according to the present invention. The compound is placed in a light path of the exciting light source for receiving the light to emit a visible light.

The exciting light source used may be, but not limited to, for example, a light-emitting diode, a laser diode, an electron beam, or plasma. The exciting light source is preferably a light having a wavelength between 380 nm and 480 nm, such as a blue light, a violet light, or an ultra-violet light. Thus, the exciting light source may be for example a light-emitting diode emitting a blue light and/or an ultra-violet light to excite the compound placed in the light path to emit a visible light. The phosphor composition may be mixed with the encapsulating material of the light source device together to perform the packing process or the phosphor composition may be coated on the surface of the encapsulating component of the light source device, to be excited by the light and emit a desired light.

Alternatively, the phosphor composition according to the present invention may be used in a blue and violet light-emitting device to combine with the blue light for obtaining a white light-emitting device. Thus, the white light-emitting device may include a blue light and an ultra-violet light as exciting lights and a phosphor composition according to the present invention. The phosphor composition is placed in the light path of the exciting light to receive the light and produce, with the blue light together, a white mixed light.

The following example gives an example of manufacturing of the phosphor material according to the present invention.

### EXAMPLE

### Example 1

### The manufacturing of the compound according to the present invention

The compound SrEuAl₂Si₁₀N₁₄O₄ was prepared by combining stoichiometric amounts of strontium carbonate (SrCO₃), aluminum nitride (AlN), silicon nitride (Si₃N₄), and europium oxide (Eu₂O₃). That is, M in the formula (I) is Eu, x=1, y=1, and z=2. The weighted raw materials were mixed uniformly by milling in a ball mill. The resulting mixture was calcined in a crucible in vacuum at about 800° C. for about 15 minutes and sintered in a nitrogen atmosphere under a pressure of 10 atm for 2 hours. After being cooled to the room temperature, a phosphor was obtained as described in the present invention.

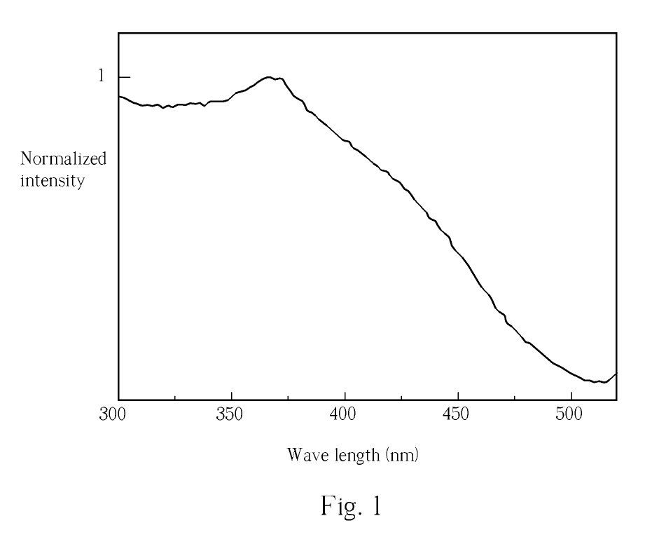

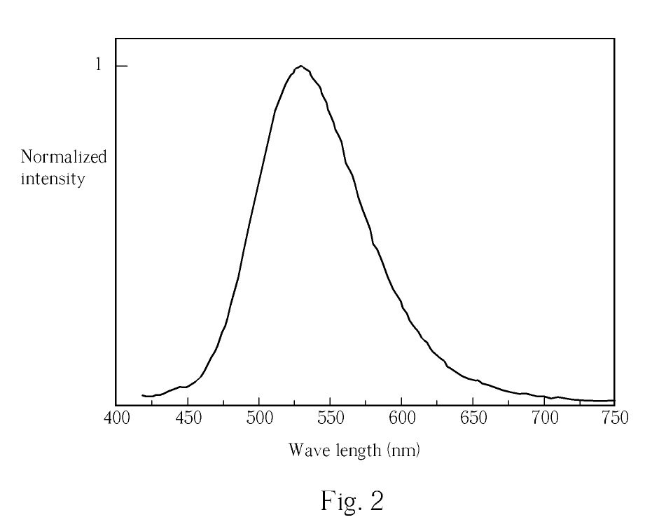

FIG. 1 shows an excitation spectrum of the phosphor SrEuAl₂Si₁₀N₁₄O₄ synthesized in the example 1. The excitation spectrum of the phosphor was obtained by detecting the intensity of the emission light of 530 nm produced by the exciting lights from 300 to 500 nm. From FIG. 1, the maximal intensity of the resulting spectrum is at 366 nm. FIG. 2 shows an emission spectrum of the phosphor SrEuAl₂Si₁₀N₁₄O₄ obtained by the excitation of the light of 366 nm. The emission spectrum is shown between 450 nm and 680 nm. From FIG. 2, it is known that the compound is a yellow-green light phosphor with a maximal emission wavelength of 530 nm.

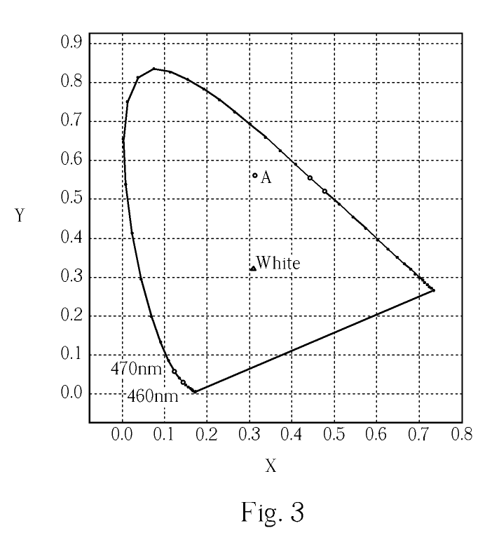

FIG. 3 shows CIE chromaticity coordinates, and the position of point A is obtained from the transformation of the emission spectrum shown in FIG. 2 using a computer simulation. It can be also noted from FIG. 3 that the phosphor is suitable to be excited by a blue light and/or an ultra-violet light and emit a yellow-green light.

### Example 2

### The Application of the Compound According to the Present Invention

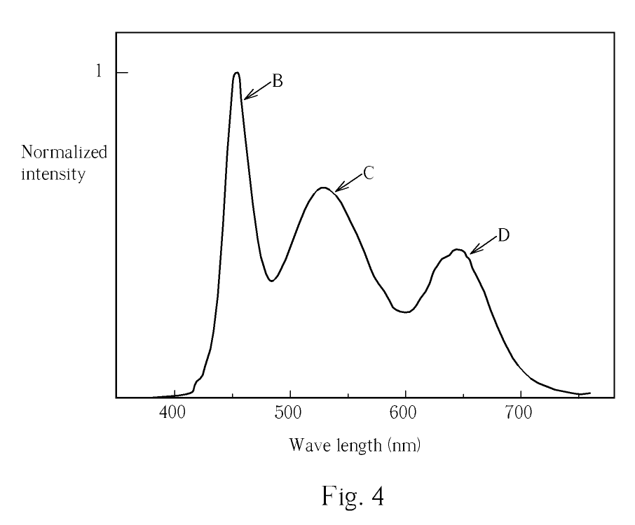

0.4 moles of SrEuAl₂Si₁₀N₁₄O₄ powder emitting a yellow-green light upon being excited by a blue light and/or an ultra-violet light obtained from Example 1 was mixed with 0.25 moles of red light phosphor CaS:Eu, forming a phosphor composition. Combining the emission spectrum of the phosphor composition with the blue light (450 nm) spectrum with a relative intensity ratio 0.6:0.4:0.25 for the yellow-green light:the red light:the blue light, a spectrum as shown in FIG. 4 was obtained. Peak B was from the blue light of 450 nm. Peak C was the emitting light from SrEuAl₂Si₁₀N₁₄O₄. Peak D was an emission spectrum of CaS:Eu red light phosphor. Thereby, a white light spectrum was obtained. The color temperature and the color rendering index of the white light is 7775K and 89, respectively.

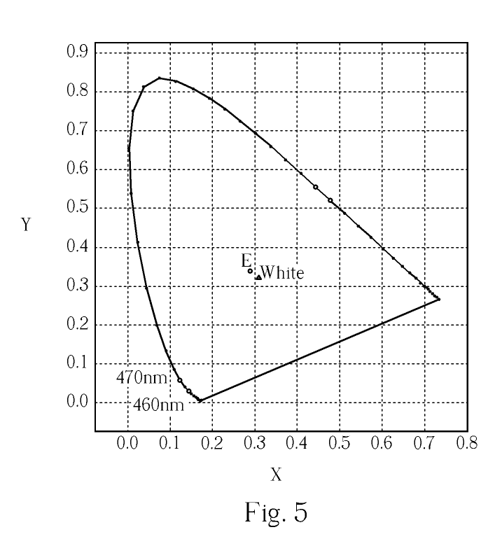

FIG. 5 shows CIE chromaticity coordinates indicating a simulated position of point E obtained from the transformation of the emission spectrum shown in FIG. 4 using a computer simulation. The triangle indicates the theoretical position for a white light. From FIG. 5, it can be noted that the position of the white light obtained is very close to the theoretical position for a white light.

The examples described above are for the illustration of the present invention, and should not be construed to limit the scope of the present invention. Any formulation with the compound, SrₓM_{y}Al_{z}Si_{12-z}N_{16-z}O_{2+z}, and method of producing a visible light by exciting the compound with a blue light and/or an ultra-violet light are in the scope of the present invention.

To compare conventional techniques with the present invention, with respect to the phosphors applied in white LEDs, in conventional techniques, three or more phosphors are needed to produce a white light, thus the limitations on manufacturing conditions are correspondingly complicated. While, in the present invention, only two phosphors are needed to produce a white light, and thus the manufacturing is much easier and the resulting white LED has a higher color rendition.

In comparison with the phosphors made from a nitride in conventional techniques, the compound according to the present invention has a different formulation. For example, U.S. Pat. No. 6,649,946 discloses two powders having chemical formula of M₂Si₅N₈ and MSi₇N₁₀, respectively, in which, M represents Ca, Sr, Ba, or Zn. Such two powders can be excited by an indigo light of wavelength of 420 nm to 470 nm to emit a light within the red light range and mainly serve as a role to enhance the color rendition. Accordingly, the patent discloses a different formulation and oxygen ion-free compounds being more difficultly synthesized.

Furthermore, a conventional silicon aluminum oxynitride (sialon) phosphor material has a formula of MeₓSi₁₂₋₍ₘ₊ₙ₎Al₍ₘ₊ₙ₎OₙN₁₆₋ₙ:Re1_{y}Re2ₓ (as disclosed by U.S. Patent Application Publication No. 20030168643). Herein, Me represents Ca, Mg, Y, or lanthanide metal excluding La or Ce. Re1 represents Ce, Pr, Eu, Tb, Yb, or Er. Re2 represents Dy. Such phosphor material mainly emits orange yellow light upon being excited by a blue light and/or an ultra-violet light, thus it is used to enhance the color rendering index, but does not serve as a main component for light mixing.

Furthermore, in comparison with a conventional oxide phosphor material excited by a blue light and/or an ultra-violet light, such as the phosphor composition disclosed in U.S. Pat. No. 6,252,254 (comprising at least one of YBO₃:Ce³⁺, Tb³⁺; BaMgAl₁₀O₁₇:Eu²⁺, Mn²⁺; (Sr,Ca,Ba)(Al,Ga)₂S₄:Eu²⁺; and Y₃Al₅O₁₂—Ce³⁺; and at least one of Y₂O₂S:Eu³⁺, Bi³⁺; YVO₄:Eu³⁺, Bi³⁺; SrS:Eu²⁺; SrY₂S₄:Eu²⁺; CaLa₂S₄:Ce³⁺; and (Ca,Sr)S:Eu²⁺), the oxygen-nitrogen compound of the present invention as a phosphor material has the following advantages:

1. The compound according to the present invention has excellent heat resistant properties, such that the quantum efficiency is still maintained at a certain level at a high temperature, as compared to conventional oxide phosphors, which suffer thermal deactivation after being used for a long time period.

2. The compound according to the present invention has properties of anti-oxidation and anti-corrosion, and, therefore, any chemical reaction of the compound with other substance to damage the light emitting properties of the compound hardly occurs, and the color saturation can be maintained after a long term use. In addition, the compound has a high hardness and a high abrasion resistance.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A compound represented by the following formula:
SrₓM_{y}Al_{z}Si_{12-z}N_{16-z}O_{2+z}
wherein, M is selected from the group consisting of rare earth elements and yttrium, x>0, y>0, x+y=2, and 0≦z≦5.

2. The compound of claim 1, wherein the rare earth elements are Ce, Pr, Eu, Tb, Yb, and Er.

3. The compound of claim 1, wherein M is Eu.

4. The compound of claim 3, wherein x is 1, y is 1, and z is 2.

5. The compound of claim 1, which is a phosphor.

6. The compound of claim 1, wherein the compound emits a visible light upon being excited by a blue light and/or an ultra-violet light.

7. The compound of claim 1, wherein M is Eu, and the compound emits a yellow-green light upon being excited by a blue light and/or an ultra-violet light.

8. The compound of claim 6, wherein the blue light and/or the ultra-violet light is a light having a wavelength between 380 nm and 480 nm.

9. The compound of claim 7, wherein the blue light and/or the ultra-violet light is a light having a wavelength between 380 nm and 480 nm.

10. A phosphor composition, comprising:
a compound represented by the following formula:
SrₓEu_{y}Al_{z}Si_{12-z}N_{16-z}O_{2+z}
wherein, x>0, y>0, x+y=2, and 0≦z≦5; and
a phosphor emitting a red light upon being excited by a blue light and/or an ultra-violet light,
wherein, each component is present in an amount such that the phosphor composition emits a light upon being excited by the blue light and/or the ultra-violet light to mix with the blue light to produce a white light.

11. The phosphor composition of claim 10, wherein the phosphor emitting red light upon being excited by a blue light and/or an ultra-violet light comprises CaS:Eu; SrS:Eu; Y₂O₂S:Eu; Y₂O₃:Eu; Y₂O₃:Eu, Bi; or Ca-α-SiAlON:Pr.

12. The phosphor composition of claim 10, wherein the blue light and/or the ultra-violet light is a light having a wavelength between 380 nm and 480 nm.

13. The phosphor composition of claim 11, wherein the blue light and/or the ultra-violet light is a light having a wavelength between 380 nm and 480 nm.

14. A light-emitting device, comprising:
an exciting light source; and
a compound represented by the following formula, positioned in a light path of the exciting light source for receiving a light to emit a visible light:
SrₓM_{y}Al_{z}Si_{12-z}N_{16-z}O_{2+z}
wherein, M is selected from the group consisting of rare earth elements and yttrium, x>0, y>0, x+y=2, and 0≦z≦5.

15. The light-emitting device of claim 14, wherein the exciting light source comprises a light-emitting diode, a laser diode, an electron beam, or plasma.

16. The light-emitting device of claim 14, wherein the exciting light source emits a light having a wavelength between 380 nm and 480 nm.

17. The light-emitting device of claim 16, wherein M is Eu, and the compound is excited by the light and emits a yellow-green light.

18. A white light-emitting device, comprising:
an exciting light source emitting a blue light and/or an ultra-violet light; and
a phosphor composition positioned in a light path of the exciting light source for receiving the blue light and/or the ultra-violet light, the phosphor composition comprising:
a compound represented by the following formula:
SrₓEu_{y}Al_{z}Si_{12-z}N_{16-z}O_{2+z}
wherein, x>0, y>0, x+y=2, and 0≦z≦5; and
a phosphor emitting red light upon being excited by the blue light and/or the ultra-violet light, wherein, the compound and the phosphor are each present in an amount such that the phosphor composition emits a light upon being excited by the blue light and/or the ultra-violet light to mix with the blue light to produce a white light.

19. The white light-emitting device of claim 18, wherein the exciting light source emitting a blue light and/or an ultra-violet light comprises a light-emitting diode, a laser diode, an electron beam, or plasma.

20. The white light-emitting device of claim 18, wherein the exciting light source emitting a blue light and/or an ultra-violet light emits a light having a wavelength between 380 nm and 480 nm.

21. The white light-emitting device of claim 18, wherein the phosphor emitting red light upon being excited by the blue light and/or the ultra-violet light comprises CaS:Eu; SrS:Eu; Y₂O₂S:Eu; Y₂O₃:Eu; Y₂O₃:Eu, Bi; or Ca-α-SiAlON:Pr.

22. A method of producing a visible light, comprising:
irradiating a compound with a blue light and/or an ultra-violet light, thereby producing a visible light, wherein the compound is represented by the following formula:
SrₓM_{y}Al_{z}Si_{12-z}N_{16-z}O_{2+z}
wherein, M is selected from the group consisting of rare earth elements and yttrium, x>0, y>0, x+y=2, and 0≦z≦5.
